(19) United States
(12) Patent Application Publication
(10) Pub. No.: US 2026/0350368 A1
(43) Pub. Date: Nov. 5, 2026

(54) CONFIGURABLE GENERATIVE CONTENT SERVICE

(71) Applicant: PolyQ.ai, Clinton Township, MI (US)

(72) Inventor: Vladimir FORFUTDINOV, Clinton Township, MI (US)

(21) Appl. No.: 19/488,029

(22) PCT Filed: May 28, 2024
(86) PCT No.: PCT/US2024/031291

§ 371 Date: Nov. 25, 2025

Related U.S. Application Data
(60) Provisional application No. 63/469,019, filed on May 25, 2023.

(51) Int. Cl. G06N 3/0475

(52) U.S. Cl. CPC G06N 3/0475

(57) ABSTRACT

Disclosed are systems, apparatuses, methods, and computer-readable media for generating content using generative content models. A method includes: receiving input of a query from a user, the query including at least a first query and a second query; transmitting the first query to a first ML model service, the first query being based on a first parameter input associated with input of the user; receiving a first response from the first ML model service based on the first query; transmitting the second query, wherein the second query is formed based on the first response and a second parameter input associated with the input of the user; and receiving a second response based on the second query; and providing a response to the query based on the second response.

### TECHNICAL FIELD

The disclosure relates generally to neural network models for generating content and, more specifically but not exclusively, to configurable generative content services.

### DESCRIPTION OF THE RELATED TECHNOLOGY

Generative models such as ChatGPT are designed to engage in dynamic and interactive conversations with users by generating human-like text responses. Generative language models, like ChatGPT, have revolutionized natural language processing by demonstrating impressive capabilities in understanding and generating coherent and contextually relevant text. Generative language models rely on deep learning techniques, particularly transformer neural networks, to learn patterns and structures in vast amounts of training data. These models are trained on a diverse range of text sources, including books, articles, websites, and other publicly available texts. During training, the model learns to predict the likelihood of a word or phrase given its surrounding context, enabling it to generate meaningful and coherent responses based on the input it receives.

Generative language models have a vast knowledge base, encompassing a wide range of topics up until its knowledge cutoff. It can provide information, answer questions, and engage in meaningful discussions on various subjects, including science, history, technology, entertainment, and more. Generative language models have limitations and rely on pre-existing information and do not have access to real-time data or the ability to browse the internet. In addition, generative language models only produce text output.

### BRIEF DESCRIPTION OF THE DRAWINGS

In order to describe the manner in which the above-recited and other advantages and features of the disclosure may be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1. is a block diagram of a prompt system including a prompt service in accordance with some aspects of the disclosure;

FIG. 2 is a conceptual diagram illustrating a single layer prompt of a prompt service in accordance with some aspects of the disclosure;

FIG. 3 is a conceptual diagram illustrating another single layer prompt of a prompt service in accordance with some aspects of the disclosure;

FIG. 4 is a conceptual diagram illustrating creation of a hierarchical prompt of a prompt service in accordance with some aspects of the disclosure;

FIG. 5 is a diagram illustrating an execution of a multilayer prompt in accordance with some aspects of the disclosure;

FIG. 6 is a diagram illustrating creation of another multilayer prompt in accordance with some aspects of the disclosure;

FIGS. 7A to 7D are various diagrams illustrating how gains are divided in accordance with some aspects of the disclosure;

FIGS. 7E to 7J are various diagrams illustrating additional aspects in accordance with some aspects of the disclosure;

FIG. 8 is an illustration of a prompt with character and output format in accordance with some aspects of the disclosure;

FIG. 9 is a conceptual illustration of a prompt creation in accordance with some aspects of the disclosure;

FIG. 10 illustrates an example method for generating content using generative content models in accordance with some aspects of the disclosure; and

FIG. 11 illustrates an example method for generating content using generative content models in accordance with some aspects of the disclosure

FIG. 12 shows an example of a computing system, which may be for example any computing device that may implement components of the system.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure may be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or may be learned by practice of the herein disclosed principles. The features and advantages of the disclosure may be realized and obtained by means of the instruments and combinations particularly pointed out in the appended claims. These and other features of the disclosure will become more fully apparent from the following description and appended claims, or may be learned by the practice of the principles set forth herein.

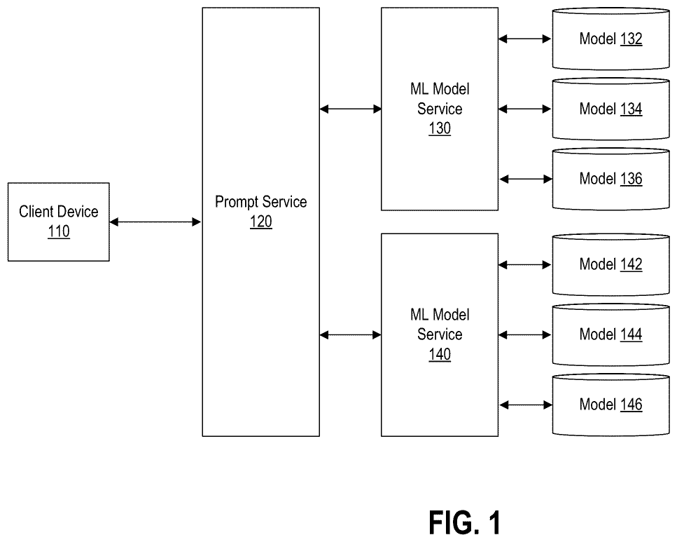

FIG. 1. is a block diagram of a prompt system 100 including a prompt service in accordance with some aspects of the disclosure. In some aspects, the prompt system includes a client device 110 that is configured to provide queries to a prompt service 120. The client device 110 includes various aspects, such as the client device 110 can be configured to build prompts for various machine learning (ML) model services, such as a first ML model service 130 and a second ML model service 140. The prompt service 120 is configured to interface with the first ML model service 130 and the second ML model service 140 to generate responses to the client. In another aspect of the client device 110, a user of the client device 110 may be a subscriber to a service that enables the user to configure predesigned prompts by prompt engineers (or prompt creators), and the user may interact with the various prompts to execute complex queries to the first ML model service 130 and the second ML model service 140.

In some aspects, the first ML model service 130 can include a plurality of models, such as model 132, model 134, and model 134, and the second ML model service 140 can include a plurality of models such as model 142, model 144, and model 146. The various models can have varying capabilities, prices, speeds, and outputs. For example, the model 132 can be configured to output embedding, which are vector representations in non-Euclidean space, model 134 can be a generative pretrained model (GPT) configured to output text, and model 136 can generate images based on text and/or image input.

In some aspects, the prompt service 120 enables complex inputs and chaining of inputs and responses from generative content services or other ML models to generate better content. For example, the prompt service 120 may enable the user to interact with a classifier ML model to classify content, and then use the classified content as an input into another generative model. The prompt service 120 may also enable various processing steps at the input, based on a response, and at an output step to the client device 110. In some cases, the prompt service 120 may allow a user to perform processing steps by adding software instructions that can be interpreted within a sandbox environment, which enables a prompt engineer to create rich and complicated services that are not possible using an ML model alone. These types of processing steps can occur before input into an ML model, after output from an ML model, or in connection with forming a series of queries. In other aspects, the prompt service 120 may be configured to cross-generate content using different ML services, for example, the first ML model service 130 and the second ML model service 140. As an example, the prompt service 120 may generate content with the first ML model service 130 and then use the generated content at least partially as input into the second ML model service 140.

In some cases, the prompts that are created can combine a plurality of input data types and parameters into rich output. For example, an input into a prompt may be an image, audio, and text, and may yield an output that is synthesized from at least one generative ML model. Non-limiting examples of output can be a meme, a video, a written description, a web component (e.g., a bundle of JavaScript and HTML that can be executed in a browser environment), audio, multimedia, text, a rich text document with multimedia content embedded, an email, or other content. As an example, a prompt engineer may create a prompt related to a celebratory event (e.g., a birthday) that takes various inputs (e.g., name, date, pictures, etc.) and synthesizes a card for the person associated with the celebratory event.

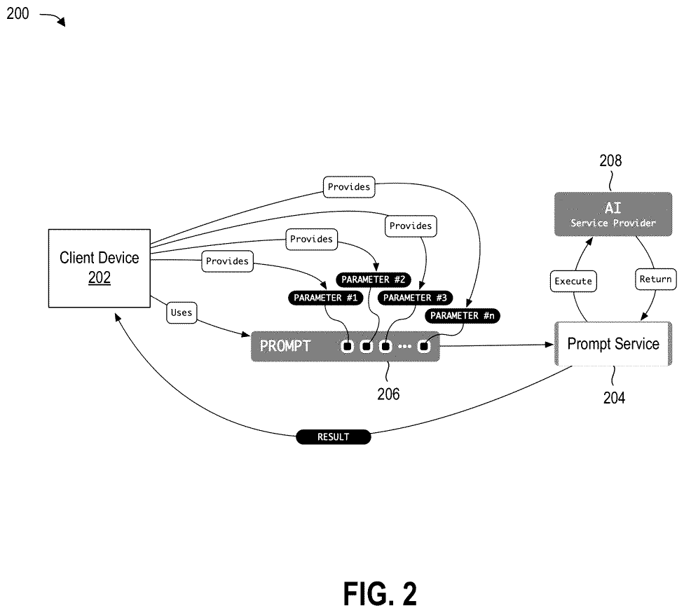

In some aspects, the prompt service 120 allows prompt engineers to create different prompts and promotes prompt engineers who are adept at using the various generative model services to create new, unique content using unconventional techniques. The prompt service 120 may provide gains to satisfy prompt engineers for the time commitment to build dynamic, flexible, and unique prompts, and surfaces modern content generation techniques for all users. In some aspects, the prompts are protected by copyright and, as further described below, creators of prompts can be rewarded based on usage and derived usage of prompts. Prompts can also be configured to legal entities to assist with various business functions such as marketing, generating social media content, and other suitable functions. Prompts may also have no parameters and may return multiple results. Various additional aspects and use cases of the prompt service 120 are further described below with reference to FIGS. 2 to 11.

In some cases, prompts may also be used as a training one or more machine learning models in various use cases. In some cases, the prompts can be classified based on use case, for example related to a particular area (e.g., law, medicine, etc.) and may be used to improve training of machine learning models. As an example, the relationship of a prompt to different classifications can be used to further train machine learning models to understand a generic prompt (e.g., can my landlord raise my rent). In this case, the prompt itself can be classified into a legal question and further classified into a domain (property and tenant rights). As further described below, prompts can also be related to a hierarchical relationship and the various relationships can be used to further refine training of machine learning models to improve application of generative models for generating various content and improving promulgation of knowledge and intelligence.

FIG. 2 is a conceptual diagram 200 illustrating a single layer prompt of a prompt service in accordance with some aspects of the disclosure. In some cases, a layer corresponds to a transaction with an ML model service (e.g., the first ML model service 130 or the second ML model service 140). In this case, a client device 202 (e.g., a user using a client device such as a mobile phone, a laptop, etc.) may interact with the prompt service 204 and select a prompt 206. For example, the prompt service may output a user interface (e.g., a web-based application, a native application, etc.) and allow the user to optionally provide at least one input associated with the prompt 206. For example, the input can be a text narrative, names, binary data, video data, audio data, image data, and so forth.

After providing the input into the prompt 206, the prompt 206 is provided to the prompt service 204, which then formulates at least one query for an ML model service 208. In some cases, the query can be formulated at the client device (e.g., the client device 110). In some aspects, the prompt service 204 can utilize an application programming interface (API) such as representational state transfer (REST) to interface with the ML model service 208. The ML model service 208 performs the requested actions and formulates a response that is provided to the prompt service 204. In response to the response from the ML model service 208, the prompt service 204 is configured to generate a response based on the query. In some cases, the response from the ML model service 208 can be directly provided to the client device 202. In other cases, the prompt service 204 may further modify the response such as by removing content that is immaterial. For example, the prompt 206 can identify relevant materials to provide to the client device 202.

In some cases, the client device 202 may be configured to directly interact with the ML model service 208 if cross-origin requests (CORS) are enabled.

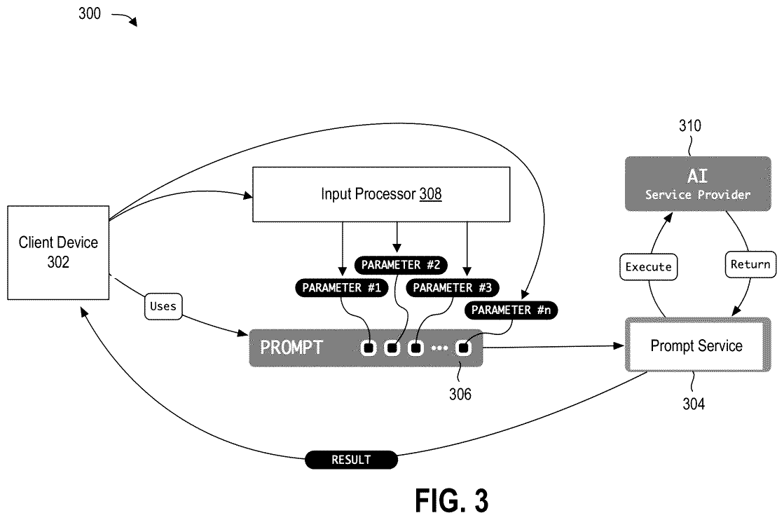

FIG. 3 is a conceptual diagram 300 illustrating another single layer prompt of a prompt service in accordance with some aspects of the disclosure. Although FIG. 3 illustrates that

In some aspects, the client device 302 may interact with a prompt service 304 for receiving a prompt 306. In this case, the prompt 306 may include an input processor 308 that is configured to perform various functions to generate a plurality of parameters. In one aspect, the prompt 306 may be a user interface input feature, such as modification of a graph or other complex data structure that is unsuitable for a point-and-click interface, and the input processor 308 is configured to generate parameters based on the input. In some cases, the client device 302 may also provide a parameter (e.g., parameter #n).

The prompt 306 is provided to the prompt service 304, which then queries an ML model service 310 (e.g., an AI service provider) based on the prompt 306 and generates a response for the client device 302. The input processor 308 can configured be in various forms. In one example, the input processor 308 is software instructions that are executed to process the input at the client device 302 and form the prompt 306. In some cases, the input processor 308 can be executed at the client device 302 or at the prompt service 304.

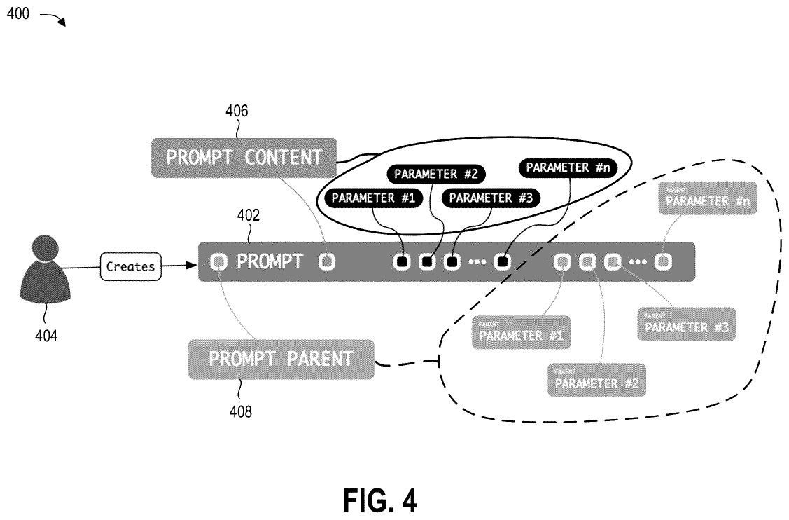

FIG. 4 is a conceptual diagram 400 illustrating creation of a hierarchical prompt of a prompt service in accordance with some aspects of the disclosure. Although FIG. 4 illustrates the creation of the prompt 402, the prompt 402 may be executed by a client device. As noted above, a prompt engineer 404 can configure the prompts for the prompt service (e.g., the prompt service 204, etc.) for use by users or subscribers. In response to use of the prompt 402, the prompt service may provide the prompt engineer 404 gains (e.g., revenue) or other credit.

In this case, the prompt engineer 404 configures the prompt 402 with multiple prompts that can be combined in different ways. In particular, the prompt engineer 404 configures a child prompt content 406 for the prompt based on a parent prompt content 408. In one example, a parent prompt content 408 includes parameters 1 to n, and the child prompt content 406 inherits all required parameters of the parent prompt content 408, and may inherit or further require optional parameters. For example, the parent prompt may be a generic prompt (e.g., create a card) and the child prompt can be a more specific variant (e.g., create a birthday card). An example of an optional parameter in the parent prompt can be a date, which is required in the child prompt (e.g., for the birthday card). In some cases, the parent prompt is configured to not be perceivable to the prompt engineer 404

In this manner, prompts may be composable and can inherit properties of any number of parent prompts. In some aspects, when the child prompt content 406 is consumed by a user of the prompt service, the prompt service may provide gains to the prompt engineer of the child prompt content 406 and the parent prompt content 408. The child prompt content 406 may also be configured to interact with the parent prompt content 408 in various ways. For example, the child prompt content 406 may be a separate input into an ML model service that the parent prompt content 408. Multiple inputs into one or more ML model services is referred to as a multilayer prompt. In some aspects, the parent prompt can have required or optional parameters. For example, Table 1 below illustrates interface definitions of a parent prompt and a child prompt.

TABLE 1

```
interface CardPrompt = {
  name: string;
  date?: Date;
  baseMessage: string;
  formatting: PromptFormat;
}
interface BirthdayCardPrompt implements CardPrompt = {
  date: Date;
  image?: Blob;
  audio?: Blob;
  recipientImage?: Blob;
  recipientInterests: string;
}
```

In this case, the CardPrompt interface includes an optional date, and the BirthdayCardPrompot interface implements the CardPrompt interface, but further requires the date, and supplements the prompt with additional parameters (e.g., image, audio, recipient image) and required parameters (recipient interests). The CardPrompt interface includes a formatting interface that may include various formatting such as default character, paragraph and type formatting, and a service provider type selection. An example of a service provider type selection may be a ML model service and a model to use for generating the response.

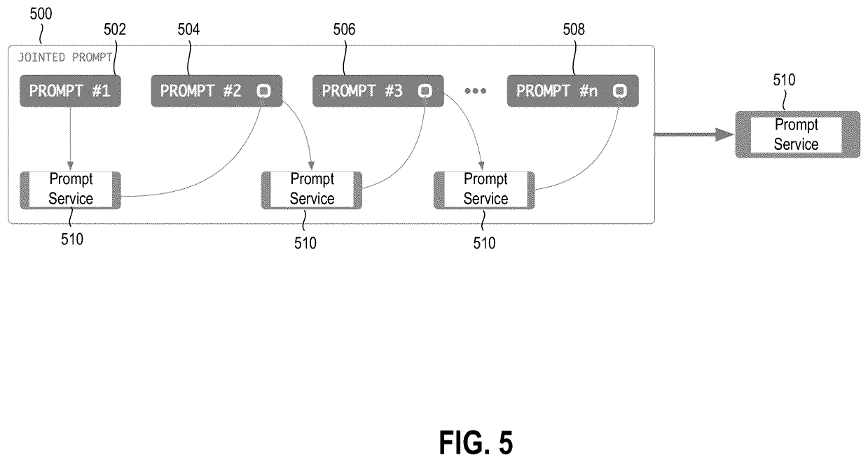

FIG. 5 is a diagram illustrating an execution of a multilayer prompt 500 in accordance with some aspects of the disclosure. In some aspects, the multilayer prompt 500 may include a series of prompts, such as a first prompt 502, a second prompt 504, a third prompt 506, and a fourth prompt 508, that are executed in conjunction with a prompt service 510. In some cases, the prompts may use the same ML model service or may use a different ML model service. In some cases, different models may also be used.

In the example illustrated in FIG. 5, a user may insert the relevant parameters into the multilayer prompt 500 and provide the multilayer prompt 500 to the prompt service 510. The prompt service 510 may perform a first prompt request (e.g., from an ML model service) using the first prompt 502 and receive a first response, perform a second prompt request based on the first response and the second prompt 504, perform a third prompt request based on a response from the second response and the third prompt 506, and perform a fourth prompt request based on a response from the third response and the fourth prompt 508.

In this case, multiple queries are performed in series to transform content based on input and different combinations. As noted above, the responses can be modified and combined with queries, different ML models (and services) can be used, and other unique content can be created based on serial application of different generative ML models.

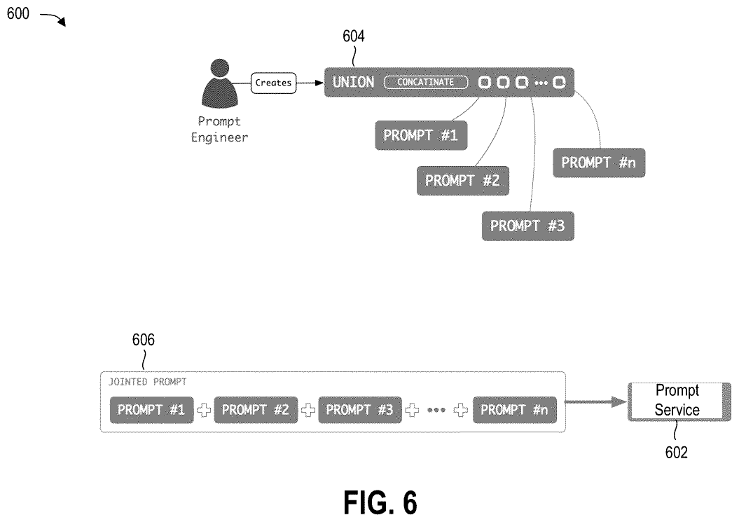

FIG. 6 is a diagram 600 illustrating creation of another multilayer prompt in accordance with some aspects of the disclosure. In some aspects, a user (e.g., a prompt engineer) using a client device may interact with a prompt service 602 to create a union prompt 604 that will be made available to users. In one illustrative aspect, the union prompt 604 is related to a series of prompts (e.g., prompts 1 to n) that are used in a single query. As shown in FIG. 6, the prompts are concatenated together into the single union prompt 604, which the prompt service 602 receives and then performs a query with an ML model service.

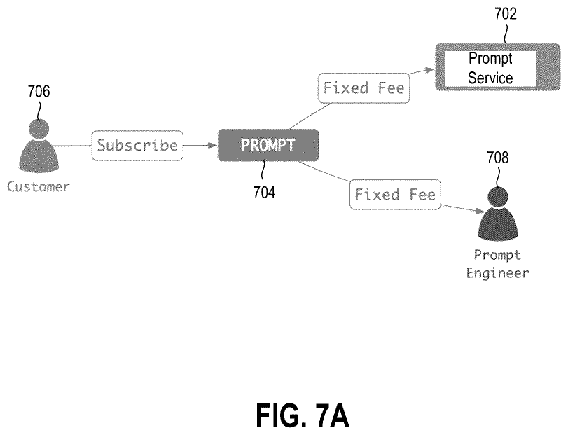

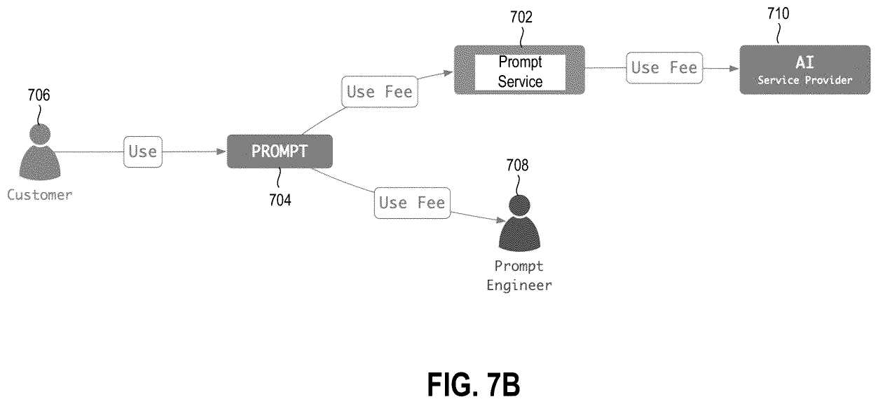

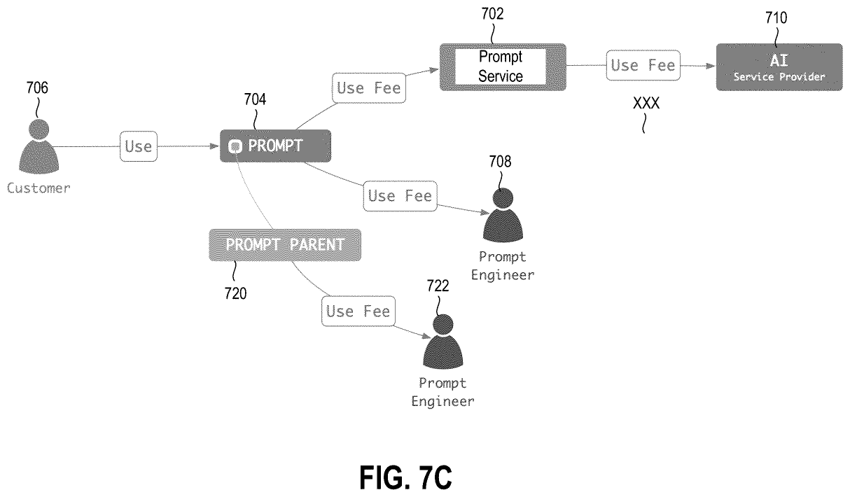

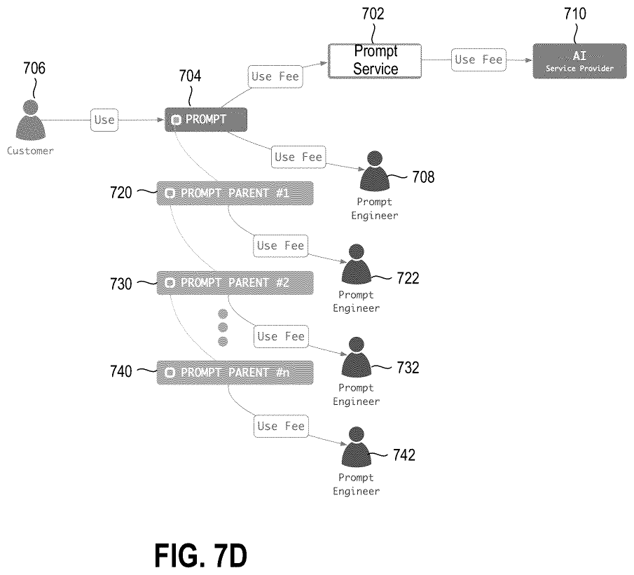

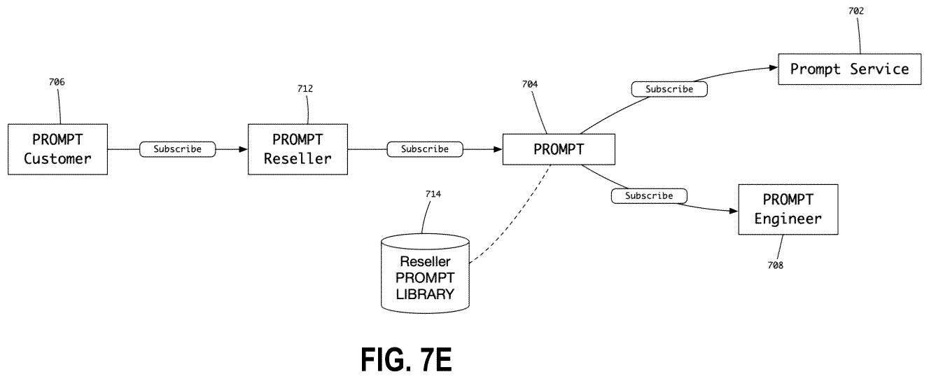

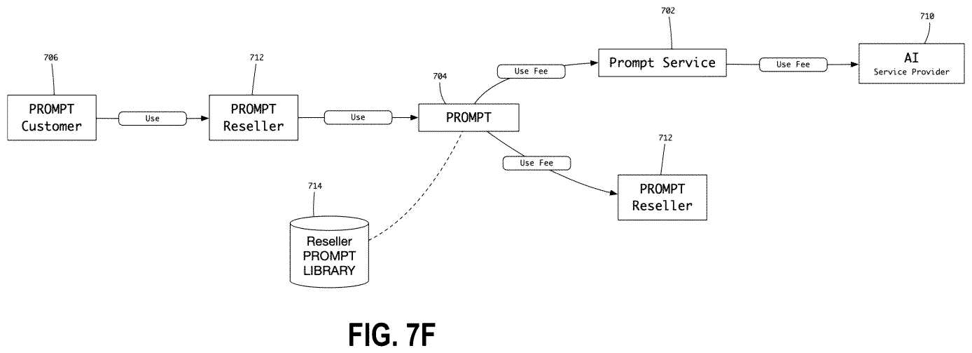

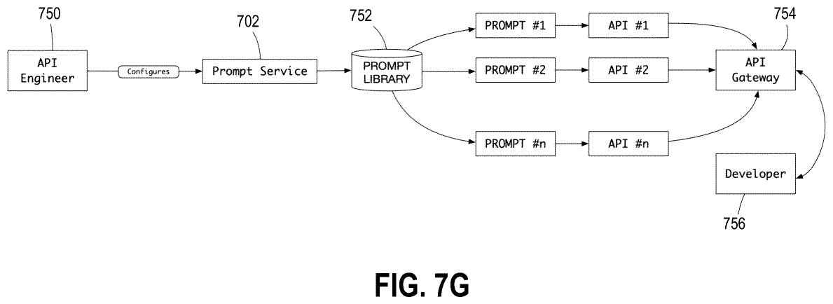

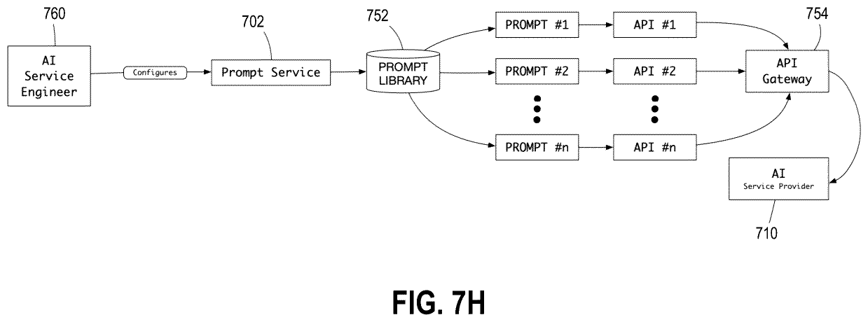

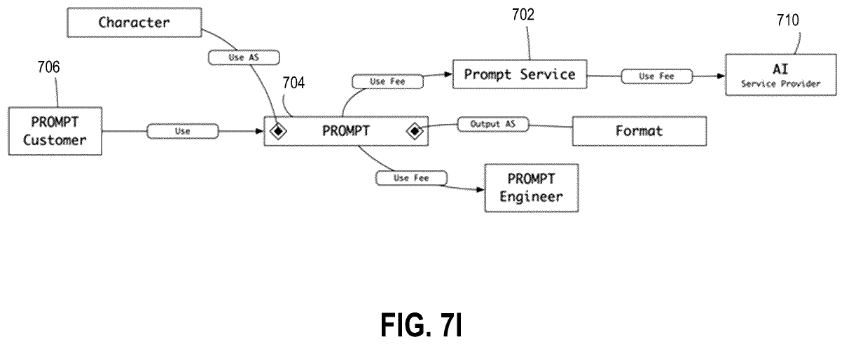

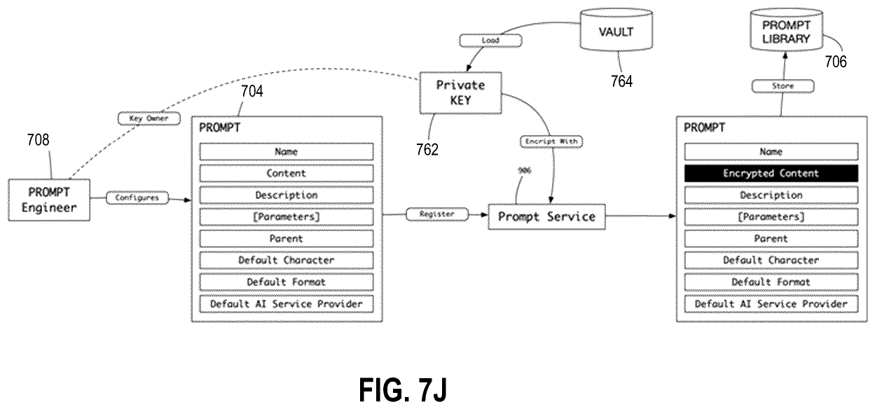

FIGS. 7A to 7D are various diagrams illustrating how gains are divided in accordance with some aspects of the disclosure.

In an aspect illustrated in FIG. 7A, a prompt service 702 provides a prompt 704 to a user 706 (e.g. a customer using a client device), and the prompt 704 is created by a prompt engineer 708. In this case, the prompt service 702 is a subscription service and enables subscribers to access created prompts. When the user 706 fills out and provides the prompt 704 to the prompt service 702, the prompt service 702 identifies how gains will be allocated between the prompt service 702 and the prompt engineer 708. In some cases, the allocations of gains are divvied based on the various factors, such as if the prompt engineer 708 has a special allocation based on their popularity.

In an aspect illustrated in FIG. 7B, a prompt service 702 may also allocate gains based on query cost associated with an ML service provider 710 (e.g., an AI service provider). In some cases, the different models of the ML service provider 710 have different prices and the prompt service 702 encourages efficient usage of the ML service provider 710 against gain provided to the prompt engineer 708. For example, the gains of the prompt engineer 708 may be discounted based on cost of the query at the ML service provider 710.

In an aspect illustrated in FIG. 7C, the prompt service 702 may also allocate gains based on reusing previous prompts. For example, the user 706 may be derived from a parent prompt 720 that was created by a second prompt engineer 722. In this case, each the prompt engineer 708 and the second prompt engineer 722 may derive gains based on various factors.

In an aspect illustrated in FIG. 7D, which is similar to FIG. 7C, the prompts may have many relationships and each prompt engineer may be provided gains. In this case, the prompt 704 is derived from the parent prompt 720, a prompt 730, and a prompt 740. Gains are provided to corresponding the second prompt engineer 722, a prompt engineer 732 who created the prompt 730, and a prompt engineer 742 who created the prompt 740.

FIGS. 7E to 7I are various diagrams illustrating additional aspects in accordance with some aspects of the disclosure.

In an aspect illustrated in FIG. 7F, the prompts may be shared and discovered using one or more subscription-based services. For example, a prompt reseller 712 may configure a reseller prompt library 714 that contains prompts associated with the reseller and/or other prompt engineers 708. In some aspects, a user 706 may subscribe to various aspects of the prompt service 702, such as a from a subscription to the prompt engineer 708 or a subscription related to types of content that is surfaced by the prompt service 702. For example, the prompt service 702 may surface particular types of prompts that can be subscribed to by the various entities (e.g., user 706, prompt reseller 712). As an example, the prompt service may identify prompts directed to a specific technology area, prompts related to legal inquiries, and so forth.

In an aspect illustrated in FIG. 7F, a prompt reseller 712 may configure a reseller prompt library 714 that contains prompts associated with the reseller and/or other prompt engineers 708. A user can subscribe to the prompt library 714 to easily browse or search various prompts and identify prompts of interest. In one example, the user 706 selects a prompt and the gains may be further distributed based on the subscription. For example, the gains may be allocated to the prompt engineer 708, the prompt service 702, the prompt reseller 712, and the ML service provider 710. The prompt service 702 enables prompt resellers 712 to identify and surface prompts having the best value to improve the user experience.

In another aspect illustrated in FIG. 7G, the prompt service 702 may enable an API engineer 750 to configure the prompt service 702 and a prompt library 752 to modify and change queries that can be surfaced to external partners using an API gateway 754, such as developer 756. In one aspect, the API engineer 750 the prompt service 702 for various changes, such as revoking encryption keys, or enabling new functionality that can be surfaced to the developer 756.

In another aspect illustrated in FIG. 7H, an AI service engineer 760 may configure the prompt service 702 with respect to one or more ML model services 710. In one aspect, the AI service engineer 760 can modify the prompt service 702, such as upgrading one or more prompts to use an updated model. For example, the updated model may include materials from an updated cutoff date, and the endpoint of the API (e.g., the universal resource indicator (URI)) may be updated to incorporate the updated materials. In other cases, the prompt library 752 may be updated to include keys that enable access to private ML models trained by a prompt engineer, or other configuration.

In another aspect illustrated in FIG. 7I, a user 706 may configure a prompt 704 for use with various character and formatting options to enable additional customization. For example, the user 702 may request a different character to be used in the prompt 704, which results in a differently formatted output. In some cases, the customization can also be related to style, such as the style or tone of language generated by the ML models.

In another aspect illustrated in FIG. 7J, additional details of a prompt 704 are illustrated and include various options. In one aspect, the prompt engineer 708 can configure a prompt 704 to include a name, content, a description, zero or more parameters, a related parent prompt, a default character, a default format, and a default ML model service. In some cases, the relationships may be implicit, for example, by using a user interface to derive the prompt 704 from the parent. The prompt engineer can also configure a private key 762 in connection with creating an encrypted communication channel between one or more endpoints of the prompt service 702. In one illustrative aspect, the private key can be stored in a vault 764 that stores corresponding public keys associated with the private key 762 to decrypt the prompt 704. For example, the private key 762 may be configured to encrypt the content associated with the prompt 704.

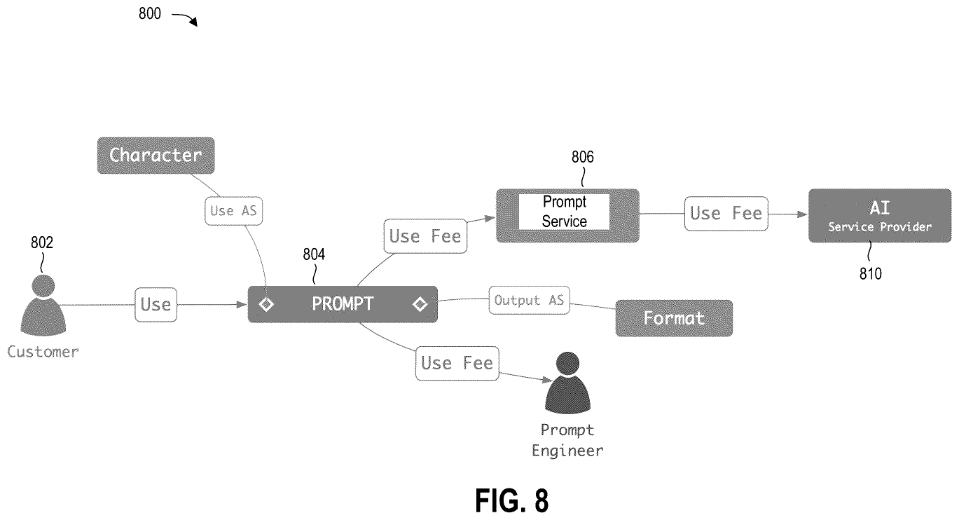

FIG. 8 is an illustration 800 of a prompt with character and output format in accordance with some aspects of the disclosure. In this aspect, a fee would not be charged for using any characters or output formats. For example, a user 802 (e.g., a subscriber) may use a prompt 804 to a prompt service 806 to query an ML model service 810. In this case, the output format is not charged to any party.

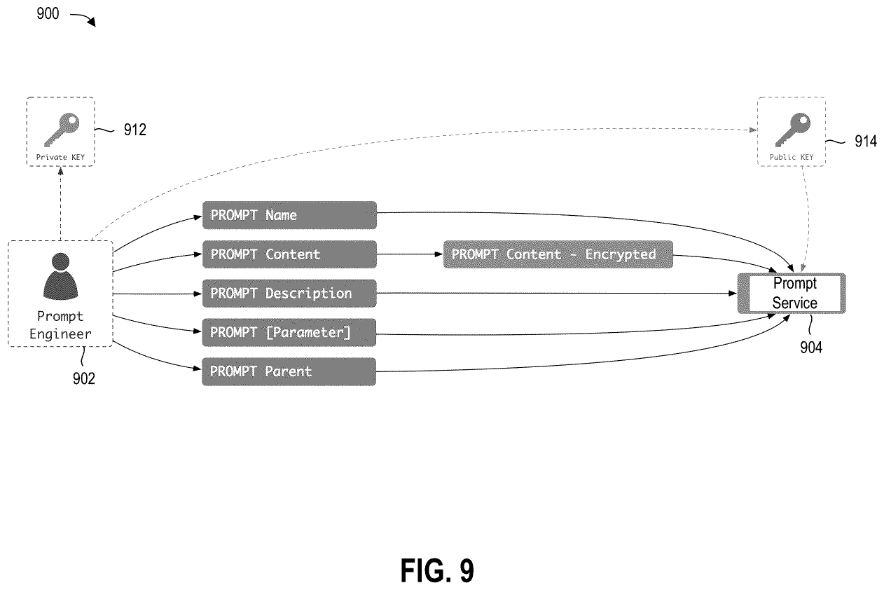

FIG. 9 is a conceptual illustration 900 of a prompt creation in accordance with some aspects of the disclosure. In some aspects, a prompt engineer 902 can create a prompt in a prompt creation message that is transmitted to a prompt service 904. For example, the prompt creation message can include a name, content, a description, a plurality of parameters, and a parent prompt. In this example, the prompt engineer 902 may be allocated a private encryption key 912 that encrypts one or more properties such as the content. The prompt service 904 may have a public key 914 that can decrypt the prompt creation message.

FIG. 9 is a conceptual illustration 900 of a prompt creation in accordance with some aspects of the disclosure. In some aspects, a prompt engineer 902 can create a prompt in a prompt creation message that is transmitted to a prompt service 904. For example, the prompt creation message can include a name, content, a description, a plurality of parameters, and a parent prompt. In this example, the prompt engineer 902 may be allocated a private encryption key 912 that encrypts one or more properties such as the content. The prompt service 904 may have a public key 914 that can decrypt the prompt creation message.

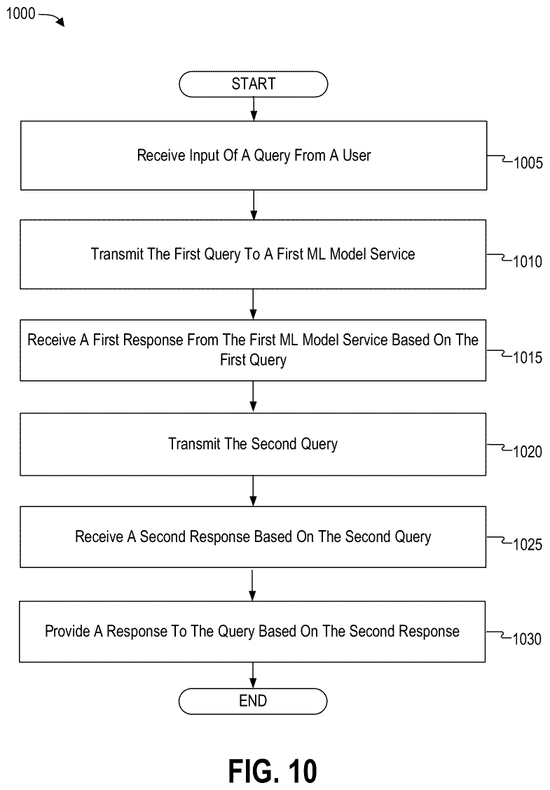

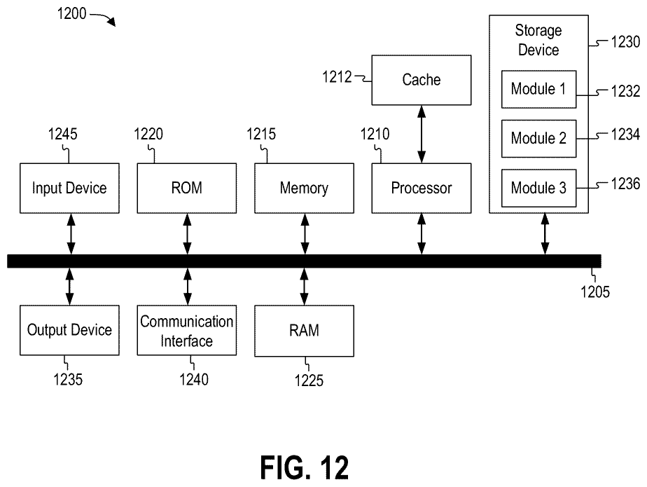

FIG. 10 illustrates an example method 1000 for generating content using generative content models in accordance with some aspects of the disclosure. Although the example method 1000 depicts a particular sequence of operations, the sequence may be altered without departing from the scope of the present disclosure. For example, some of the operations depicted may be performed in parallel or in a different sequence that does not materially affect the function of the method 1000. In other examples, different components of an example device or system that implements the method 1000 may perform functions at substantially the same time or in a specific sequence. In some aspects, the method may be performed by a computing system (e.g., the computing system 1200 in FIG. 12).

At block 1005, the computing system may receive input of a query from a user. According to some aspects, the query includes at least a first query and a second query. In some aspects, the computing system may, as part of block 1005, execute instructions associated with input by a creator of the first query to extract the first parameter. For example, a prompt engineer may provide instructions to extract and modify inputs at the prompt service. The instructions may execute in a sandbox for security precautions.

At block 1010, the computing system may transmit the first query to a first ML model service. In this case, the first query is based on a first parameter input associated with input of the user.

At block 1015, the computing system may receive a first response from the first ML model service based on the first query. In some cases, the computing system may process the output, prepare an input based on the output, or various other operations. In one aspect, the computing system may execute instructions associated with input by a creator of the first query to extract the second parameter based on the first response. In another aspect, the computing system may execute instructions associated with input by a creator of the second query to form the second query based on the first response.

At block 1020, the computing system may transmit the second query. In some cases, the second response is generated based on the first ML model service referring to the first response. For example, the queries can be related and an identifier from the first ML model service can provide a unique identifier to enable further content generation based on the first query. In other cases, the second query is provided to a second ML model service that is associated with a different domain name than the first ML model service. For example, the first ML model service may be associated with OpenAI, and the second ML model service may be Google. The second ML model service is associated with a different machine learning model than the first ML model service. In some cases, the second query is formed based on the first response and a second parameter input associated with the input of the user.

At block 1025, the computing system may receive a second response based on the second query.

At block 1030, the computing system may provide a response to the query based on the second response. A first credit is provided to a first creator based on the first query or the second query. A second credit is provided to the second creator. The first query or the second query is based on a parent query created by the second creator.

In some aspects, the computing system may identify at least one creator associated with the query. Based on identifying at least one creator, the computing system may determine credit (or gain) to provide the at least one creator based on the query.

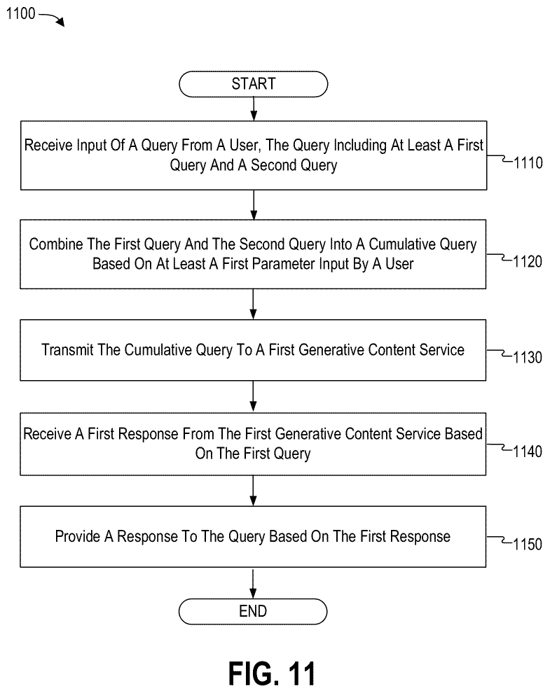

FIG. 11 illustrates an example method 1100 for generating content using generative content models. Although the example method 1100 depicts a particular sequence of operations, the sequence may be altered without departing from the scope of the present disclosure. For example, some of the operations depicted may be performed in parallel or in a different sequence that does not materially affect the function of the method 1100. In other examples, different components of an example device or system that implements the method 1100 may perform functions at substantially the same time or in a specific sequence. In some aspects, the method may be performed by a computing system (e.g., the computing system 1200 in FIG. 12).

At block 1110, the computing system may receive input of a query from a user, the query including at least a first query and a second query.

At block 1120, the computing system may combine the first query and the second query into a cumulative query based on at least a first parameter input by a user.

At block 1130, the computing system may transmit the cumulative query to a first generative content service.

At block 1140, the computing system may receive a first response from the first generative content service based on the first query.

At block 1150, the computing system may provide a response to the query based on the first response.

FIG. 12 shows an example of computing system 1200, which may be for example any computing device making up the various roles described above or any component thereof in which the components of the system are in communication with each other using connection 1205. Connection 1205 may be a physical connection via a bus, or a direct connection to processor 1210, such as in a chipset architecture. Connection 1205 may also be a virtual connection, networked connection, or logical connection.

In some embodiments, computing system 1200 is a distributed system in which the functions described in this disclosure may be distributed within a datacenter, multiple datacenters, a peer network, etc. In some embodiments, one or more of the described system components represents many such components each performing some or all of the function for which the component is described. In some embodiments, the components may be physical or virtual devices.

Example system 1200 includes at least one processing unit (CPU or processor) 1210 and connection 1205 that couples various system components including system memory 1215, such as ROM 1220 and RAM 1225 to processor 1210. Computing system 1200 may include a cache of high-speed memory 1212 connected directly with, in close proximity to, or integrated as part of processor 1210.

Processor 1210 may include any general purpose processor and a hardware service or software service, such as services 1232, 1234, and 1236 stored in storage device 1230, configured to control the processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which may represent any number of input mechanisms, such as a microphone for speech, a touch-sensitive screen for gesture or graphical input, keyboard, mouse, motion input, speech, etc. Computing system 1200 may also include output device 1235, which may be one or more of a number of output mechanisms known to those of skill in the art. In some instances, multimodal systems may enable a user to provide multiple types of input/output to communicate with computing system 1200. Computing system 1200 may include communications interface 1240, which may generally govern and manage the user input and system output. There is no restriction on operating on any particular hardware arrangement and therefore the basic features here may easily be substituted for improved hardware or firmware arrangements as they are developed.

Storage device 1230 may be a non-volatile memory device and may be a hard disk or other types of computer readable media which may store data that are accessible by a computer, such as magnetic cassettes, flash memory cards, solid state memory devices, digital versatile disks, cartridges, RAM, ROM, and/or some combination of these devices.

The storage device 1230 may include software services, servers, services, etc., that when the code that defines such software is executed by the processor 1210, it causes the system to perform a function. In some embodiments, a hardware service that performs a particular function may include the software component stored in a computer-readable medium in connection with the necessary hardware components, such as processor 1210, connection 1205, output device 1235, etc., to carry out the function.

Devices implementing methods according to these disclosures may comprise hardware, firmware and/or software, and may take any of a variety of form factors. Typical examples of such form factors include servers, laptops, smart phones, small form factor personal computers, personal digital assistants, and so on. Functionality described herein also may be embodied in peripherals or add-in cards. Such functionality may also be implemented on a circuit board among different chips or different processes executing in a single device, by way of further example.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service may be software that resides in memory of a client device and/or one or more servers of a content management system and perform one or more functions when a processor executes the software associated with the service. In some embodiments, a service is a program, or a collection of programs that carry out a specific function. In some embodiments, a service may be considered a server. The memory may be a non-transitory computer-readable medium.

In some embodiments the computer-readable storage devices, mediums, and memories may include a cable or wireless signal containing a bit stream and the like. However, when mentioned, non-transitory computer-readable storage media expressly exclude media such as energy, carrier signals, electromagnetic waves, and signals per se.

Methods according to the above-described examples may be implemented using computer-executable instructions that are stored or otherwise available from computer readable media. Such instructions may comprise, for example, instructions and data which cause or otherwise configure a general-purpose computer, special purpose computer, or special purpose processing device to perform a certain function or group of functions. Portions of computer resources used may be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures may comprise hardware, firmware and/or software, and may take any of a variety of form factors. Typical examples of such form factors include servers, laptops, smartphones, small form factor personal computers, personal digital assistants, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality may be distributed differently or performed in components other than those identified herein. Rather, the described features and steps are disclosed as examples of components of systems and methods within the scope of the appended claims.

What is claimed is:

1. A method for generating content, comprising:
receiving input of a query from a user, the query including at least a first query and a second query;
transmitting the first query to a first ML model service, the first query being based on a first parameter input associated with input of the user;
receiving a first response from the first ML model service based on the first query;
transmitting the second query, wherein the second query is formed based on the first response and a second parameter input associated with the input of the user; and
receiving a second response based on the second query; and
providing a response to the query based on the second response.

2. The method of claim 1, wherein the second query includes an identifier associated with the first query, and wherein the second response is generated based on the first ML model service referring to the first response.

3. The method of claim 1, wherein the second query is provided to a second ML model service.

4. The method of claim 3, wherein the second generative content service is associated with a different domain name than the first ML model service.

5. The method of claim 4, wherein the second generative content service is associated with a different machine learning model than the first ML model service.

6. The method of claim 1, further comprising:
identifying at least one creator associated with the query; and
identifying credit to provide the at least one creator based on the query.

7. The method of claim 1, wherein a first credit is provided to a first creator based on the first query or the second query, and a second credit is provided to the second creator, wherein the first query or the second query is based on a parent query created by the second creator.

8. The method of claim 1, further comprising:
executing instructions associated with input by a creator of the first query to extract the first parameter.

9. The method of claim 1, further comprising:
executing instructions associated with input by a creator of the first query to extract the second parameter based on the first response.

10. The method of claim 1, further comprising:
executing instructions associated with input by a creator of the second query to form the second query based on the first response.

11. A method for generating content, comprising:
receiving input of a query from a user, the query including at least a first query and a second query;
combining the first query and the second query into a cumulative query based on at least a first parameter input by a user;
transmitting the cumulative query to a first generative content service; and
receiving a first response from the first generative content service based on the first query; and
providing a response to the query based on the first response.
